(19) United States
(12) Patent Application Publication
(10) Pub. No.: US 2005/0127122 A1
(43) Pub. Date: Jun. 16, 2005

(54) Universal Feature Attachment System

(75) Inventors: John McKenzie, Royal Oak, MI (US); Alan Sturt, West Bloomfield, MI (US); Thomas S. Hicks, Livonia, MI (US); Jeff A. Kempf, Romeo, MI (US)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/707,432

(22) Filed: Dec. 12, 2003

(51) Int. Cl. B60R 7/00; B60R 9/00; B60R 11/00

(52) U.S. Cl. 224/547

(57) ABSTRACT

Disclosed is a universal, in-vehicle attachment system comprising open slots whereby a similarly shaped storage unit with complimentary prongs is inserted, providing a secure and easy fastening attachment device designed to secure devices and items in place within the vehicle such as, for example, cellular phones, CDs or DVDs, bottles, mugs, cups, coolers, bike racks, and PDAs. This in-vehicle storage or securing attachment system can be molded to conform directly to the size and shape of the particular object or, alternatively, a more generic type receptacle can be used to secure such items. Further, the in-vehicle attachment system is incorporated into the vehicle, with multiple locations, including the seat back panel, instrument panel, door panel, quarter panel, floor panel, or other interior surfaces.

### BACKGROUND OF INVENTION

1. Field of the Invention

The present invention generally relates to an item securing system that is adaptable to hold a variety of items in a secure and user accessible manner within a vehicle. The present invention further relates to an item securing system that allows stored devices to be transferred between several vehicles equipped with the present invention.

2. Description of the Related Art

Consumers are continually seeking more efficient, convenient, versatile and secure ways to transport or store contents which are stowed or utilized in a motor vehicle such as a van, minivan, and passenger sedan and sport utility vehicle. Conventional means of stowing items within the vehicle have been trunk space, the floor of the vehicle, the area behind the seats, and pre-formed brackets such as cup holders, change holders and the like.

For example, U.S. Pat. No. 4,418,733 issued Dec. 6, 1983 to Kallman teaches the use of hook and loop materials for attaching receptacles such as beverage holders, pouches and the like to a surface on or in a vehicle.

U.S. Pat. No. 4,708,549 issued Nov. 24, 1987 to Jensen teaches a bolt down anchor fitting for use in tracks in vehicles and aircraft for example where heavy loads such as cargo containers and passenger occupied seating must be secured and not be prone to vibration loosening.

U.S. Pat. No. 5,139,375 issued Aug. 18, 1992 to Franchuk teaches a bolt down bar rail system allowing for mounting of tie-downs, racks and other devices to the open bed of a truck.

U.S. Pat. No. 5,255,832 issued Oct. 26, 1993 to Christensen teaches a rail mounting system for use in truck beds to allow for mounting equipment such as tool boxes.

U.S. Pat. No. 5,642,845 issued Jul. 1, 1997 to Van Kooten teaches a permanently mounted tool box locking device for use in truck beds.

U.S. Pat. No. 5,653,366 issued Aug. 5, 1997 to Liserre teaches a mounting means for mounting a security box to the floor of a vehicle.

U.S. Pat. No. 5,730,346 issued Mar. 24, 1998 to Adams et al teaches a strap and mounting block assembly to allow the attaching of cargo alongside a vehicle or building. The assembly requires the use of mounting brackets being permanently attached to the building or vehicle.

U.S. Pat. No. 5,769,294 issued Jun. 23, 1998 to Heinz et al teaches a recessed accessory hook for use on the interior of a vehicle.

U.S. Pat. No. 6,349,865 issued Feb. 26, 2002 to Tolley et al teaches a collapsible pouch-like storage container for securing objects in the bed of a truck. The storage container is fixedly attached to the truck bed.

U.S. Pat. No. 6,547,117 issued Apr. 15, 2003 to Glovatsky et al teaches a beverage container holder for use in vehicles that utilizes a sensor and continuous moldline technology which changes shape to grip a container placed in the holder.

U.S. Pat. No. 6,550,654 issued Apr. 22, 2003 to Crago teaches a removable cargo net for use in a vehicle which utilizes a permanently mounted frame member to receive and hold net retainers located around the periphery of the net.

U.S. patent application Publication No. 2001/0054632 published Dec. 27, 2001 to Larsen et al teaches an apparatus that can be clamped to the floor attachments of a motor vehicle used to secure removable seats. The securing of the apparatus to the floor attachments is accomplished by pincers that lock around the floor attachment bars.

With consumer spending more time in their vehicles than ever-before, the tendency or need to have personal items in the vehicle is more prevalent. For example, more drivers and passengers carry mobile phones, coffee mugs, CDs and DVDs in their vehicles. However, storage and secure retention of such items has routinely been a concern for consumers. In addition, there is an ever-growing concern about leaving such devices as well as PDAs and the like in open view when the vehicle is not occupied.

Accordingly, there is a need for a attachment and storage system for such items that provides secure safe storage while allowing use of the secured devices by drivers and passengers while occupying the vehicle.

### DISCLOSURE OF THE INVENTION

The present invention provides advantages and alternatives over the prior art by providing a universal, in-vehicle attachment system comprising at least one open slot wherein any item equipped with at least one complimentary prong can be inserted, providing a secure and easy fastening attachment device. The present invention may be designed to secure devices and items in place within the vehicle such as, for example, cellular phones, CDs or DVDs, bottles, mugs, cups, coolers, bike racks, and PDAs. Further the storage or securing device can be molded to conform directly to the size and shape of the particular object or, alternatively, a more generic type receptacle can be used to secure such items.

According to a further aspect of the present invention, there is provided an in-vehicle attachment system designed and incorporated into the vehicle, with multiple locations, including the trim panel, seat back panel, instrument panel, door panel, quarter panel, floor panel, or other similar interior surfaces. Additionally, the storage units may be transferred between vehicles having the in-vehicle attachment system of the present invention without vehicle specific storage containers.

According to yet another aspect of the present invention there is provided a device mounting apparatus suitable for mounting items in a vehicle comprising in cooperative combination: a universal mounting unit mounted in an interior panel or floor of a vehicle having located therein at least one mounting cavity; a storage receptacle having located thereon at least one prong suitable for inserting into said at least one mounting cavity; thereby allowing the mounting of a desired device in a vehicle.

The present invention thus advantageously provides a universal device attachment and storage system that is easy to use, cost effective and in which the storage units themselves may be used in multiple vehicles without special adapters or modifications.

### BRIEF DESCRIPTION OF DRAWINGS

FIG. 1 shows a perspective view of one embodiment of the attachment system of the present invention.

FIG. 2 shows a partial perspective view of one embodiment of the attachment system of the present invention mounted in an interior panel of a vehicle in a closed or non-use position.

FIG. 3 shows a partial perspective view of one embodiment of the attachment system of the present invention mounted in an interior panel of a vehicle starting to be brought into a use position.

FIG. 4 show a partial perspective view of one embodiment of the attachment system of the present invention mounted in an interior panel of a vehicle in an almost completely open position.

FIG. 5 shows a partial perspective view of one embodiment of the attachment system of the present invention mounted in an interior panel of a vehicle in a fully open use position.

FIG. 6 shows a partial perspective view of another embodiment of the attachment system of the present invention mounted in an interior panel of a vehicle in a closed or non-use position.

FIG. 7 shows a partial perspective view of another embodiment of the attachment system of the present invention mounted in an interior panel of a vehicle starting to be brought into a use position.

FIG. 8 show a partial perspective view of another embodiment of the attachment system of the present invention mounted in an interior panel of a vehicle in an almost completely open position.

FIG. 9 shows a partial perspective view of another embodiment of the attachment system of the present invention mounted in an interior panel of a vehicle in a fully open use position.

FIG. 10 shows a partial exploded perspective view of the cavities and prongs of the present invention used in the embodiment presented in FIG. 10.

FIG. 11 shows a partial perspective view of another preferred embodiment of the attachment system of the present invention mounted in an interior panel of a vehicle in a closed or non-use position.

FIG. 12 shows a partial perspective view of another preferred embodiment of the attachment system of the present invention mounted in an interior panel of a vehicle starting to be brought into a use position.

FIG. 13 show a partial perspective view of another preferred embodiment of the attachment system of the present invention mounted in an interior panel of a vehicle in an almost completely open position.

FIG. 14 shows a partial perspective view of another preferred embodiment of the attachment system of the present invention mounted in an interior panel of a vehicle in a fully open use position.

FIG. 15 shows a perspective view of an alternative preferred embodiment of the present invention.

FIG. 16 shows perspective view another preferred embodiment of the present invention.

FIG. 17 shows perspective view of yet another preferred embodiment of the present invention.

FIG. 18 shows a top plan view of the embodiment of the present invention shown in FIG. 17.

FIG. 19 shows a perspective view of still another embodiment of the present invention.

FIG. 20 shows a perspective view of a preferred embodiment of the present invention wherein the mounting cavity is located in the storage receptacle or item and the corresponding prong is located on the mounting unit.

### DETAILED DESCRIPTION

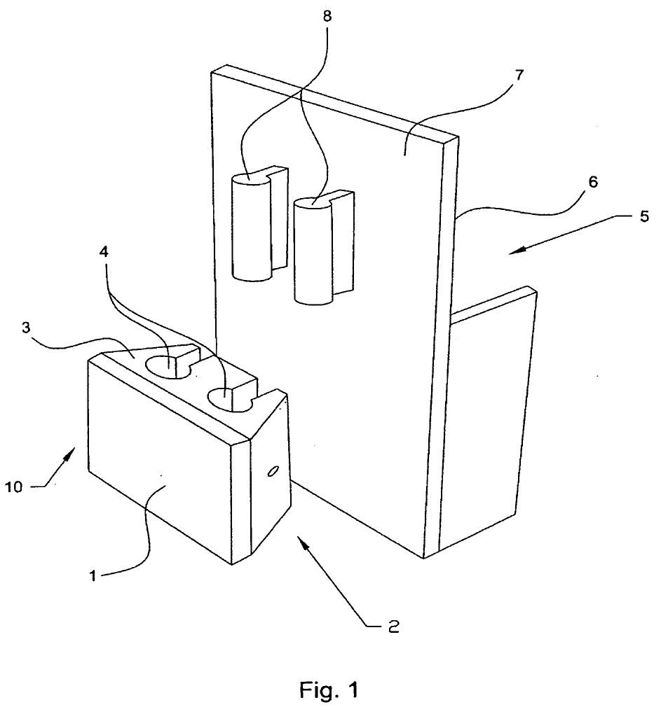

Reference will now be made to the drawings, wherein to the extent possible like reference numerals are utilized to designate like components throughout the various views. Referring to FIG. 1, there is presented one embodiment of the present invention comprising universal mount unit 10 having a closed position side 1, an open use position side 2 having a mounting section 3 containing at least one vertical mounting cavity 4 therein.

As further shown in FIG. 1 there is shown a storage receptacle 5 having a device storage side 6 and a mounting side 7, said mounting side 7 having at least one corresponding mounting prong 8 of a desired shape and size to be received and held by the at least one vertical mounting cavity 4. The storage receptacle 5 may have storage side 6 with any desired shape and size to accommodate a variety of occupant devices such as cell phones, beverage containers, CDs and DVDs for example. The in-vehicle attachment system of the present invention may be incorporated into the vehicle, with multiple locations, including the seat back panel, instrument panel, door panel, quarter panel, floor panel, or other interior surfaces. Referring now to FIGS. 2, 3, 4 and 5, there is shown one preferred embodiment of the present invention where the universal mounting unit 10 may be hidden in a closed position when not in use to prevent the present invention from interfering with other objects in the vehicle or with occupants when the universal mounting unit 10 is not in use.

More particularly FIG. 2 shows a partial perspective view of a vehicle interior panel 20 having a universal mounting unit 10 mounted in a interior panel cavity 21 (see FIGS. 3 and 4) showing only the universal mounting unit 10 closed side 1.

FIG. 3 shows a partial perspective view of a vehicle interior panel 20 having mounting cavity 21 with universal mounting unit 10 mounted therein where said universal mounting unit 10 has started to be opened and the closed side 1 as well as part of open use position side 2 having mounting section 3 containing vertical mounting cavities 4 is also visible.

FIG. 4 show a partial perspective view of a vehicle interior panel 20 having a mounting cavity 21 with universal mounting unit 10 mounted therein where most of the open use position side 2 having a pair of mounting sections 3 containing vertical mounting cavities 4 is visible though not yet completely open into the use position.

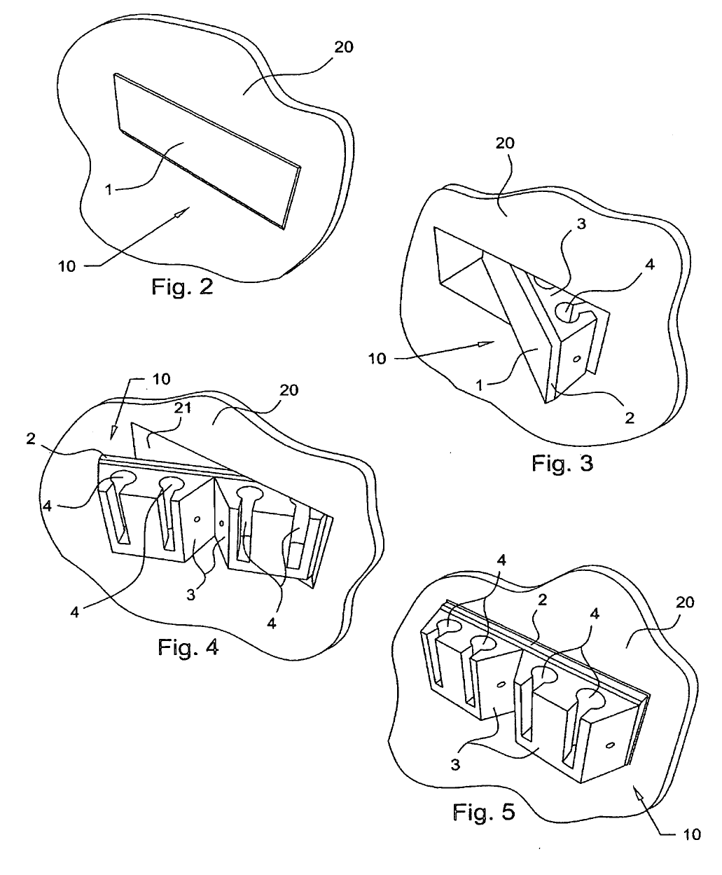

Finally in FIG. 5 there is shown a partial perspective view of a vehicle interior panel 20 with universal mounting unit 10 in a fully open use position and showing a pair of mounting sections 3 each having at least one vertical mounting cavity 4 located in each mounting section 3 therein for receiving the corresponding at least two mounting prongs 8.

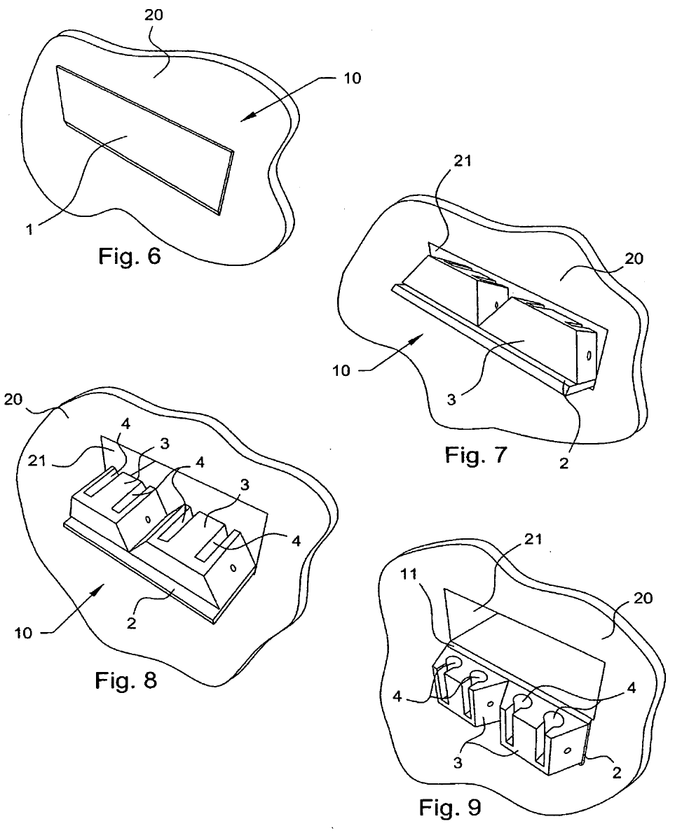

FIGS. 6, 7, 8, and 9 shows a partial perspective view of another preferred embodiment of the present invention where the universal mounting unit 10 may be hidden in a closed position when not in use to prevent the present invention from interfering with other objects in the vehicle or with occupants when the universal mounting unit 10 is not in use.

More particularly FIG. 6 shows a partial perspective view of a vehicle interior panel 20 having a universal mounting unit 10 mounted in a interior panel cavity 21 (see FIGS. 7, 8 and 9) showing only the universal mounting unit 10 closed side 1.

FIG. 7 shows a partial perspective view of a vehicle interior panel 20 having mounting cavity 21 with universal mounting unit 10 mounted therein where said universal mounting unit 10 has started to be opened and part of open use position side 2 having mounting section 3 containing vertical mounting cavities 4 (see FIGS. 8 and 9) is also visible.

FIG. 8 shows a partial perspective view of a vehicle interior panel 20 having a mounting cavity 21 with universal mounting unit 10 mounted therein where most of the open use position side 2 having a pair of mounting sections 3 containing vertical mounting cavities 4 is visible though not yet completely open into the use position.

Finally in FIG. 9 there is shown a partial perspective view of a vehicle interior panel 20 with universal mounting unit 10 in a fully open use position and showing a pair of mounting sections 3 each having at least one vertical mounting cavity 4 located in each mounting section 3 therein for receiving the corresponding at least two mounting prongs 8. Also shown is hinge 11.

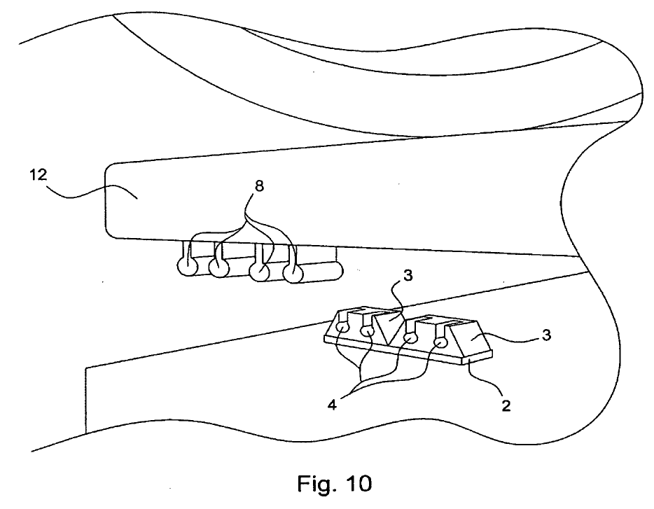

FIG. 10 shows an exploded partial section of the embodiment of the present invention 10 shown in FIG. 10 illustrating how mounting sections 3 with horizontally orientated mounting cavities 4 are located on the vehicle floor. Also illustrated is the position of the corresponding prongs 8 located on the cargo-securing bracket 12 which seat in said mounting cavities 4 holding the cargo-securing bracket 12 to the vehicle floor. The cargo-securing bracket 12 may be cross car beams to mount bicycles or the like, or brackets to mount shelving, as way of example.

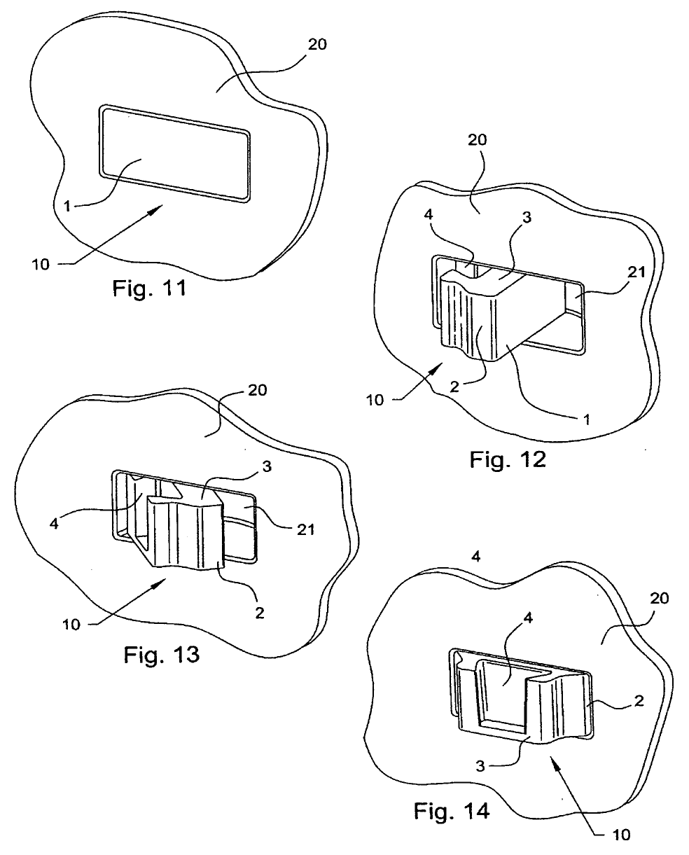

Referring now to FIGS. 11, 12, 13 and 14, there is shown another preferred embodiment of the present invention where the universal mounting unit 10 may be hidden in a closed position when not in use to prevent the present invention from interfering with other objects in the vehicle or with occupants when the universal mounting unit 10 is not in use.

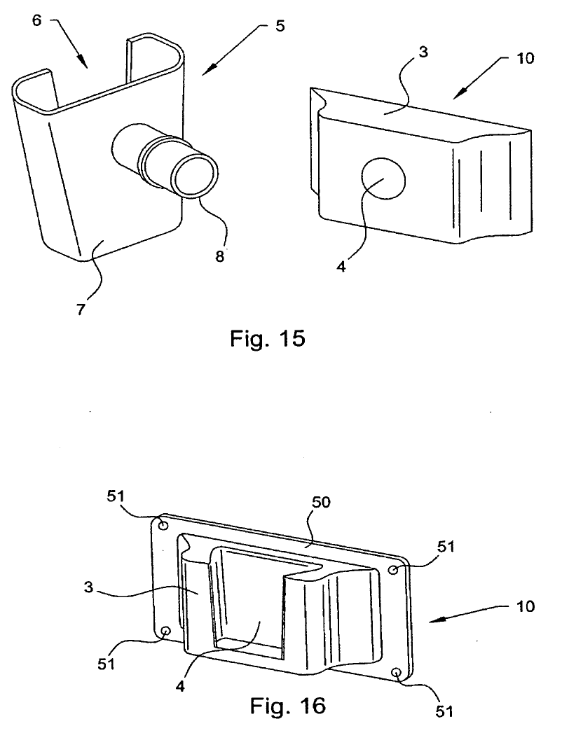

More particularly FIG. 11 shows a partial perspective view of a vehicle interior panel 20 having a universal mounting unit 10 mounted in a interior panel cavity 21 (see FIGS. 13 and 14) showing only the universal mounting unit 10 closed side 1.

FIG. 12 shows a partial perspective view of a vehicle interior panel 20 having mounting cavity 21 with universal mounting unit 10 mounted therein where said universal mounting unit 10 has started to be opened and the closed side 1 as well as part of open use position side 2 having mounting section 3 containing a single vertical mounting cavity 4 is also visible.

FIG. 13 show a partial perspective view of a vehicle interior panel 20 having a mounting cavity 21 with universal mounting unit 10 mounted therein where most of the open use position side 2 having a mounting section 3 containing a single vertical mounting cavity 4 is visible though not yet completely open into the use position.

In FIG. 14 there is shown a partial perspective view of a vehicle interior panel 20 with universal mounting unit 10 in a fully open use position and showing a single mounting section 3 having at least one vertical mounting cavity 4 located in mounting section 3 therein for receiving the corresponding at least one mounting prong 8.

FIG. 15 shows a perspective view of the universal mounting unit 10 with a mounting section 3 having therein at least one horizontal mounting cavity 4 and a storage receptacle 5 having at least one corresponding horizontal prong 8 located on the mounting side 7 as well as showing device storage side 6.

FIG. 16 shows an alternative form of mounting unit 10 having mounting section 3 and mounting cavity 4 therein and further having mounting unit-securing plate 50 with bores 51 for mounting said mounting unit 10 by means of known fasteners (not shown). It is to be understood that mounting unit-securing plate 50 and mounting unit 10 may be separate pieces that are attached together or preferably formed as a single unit.

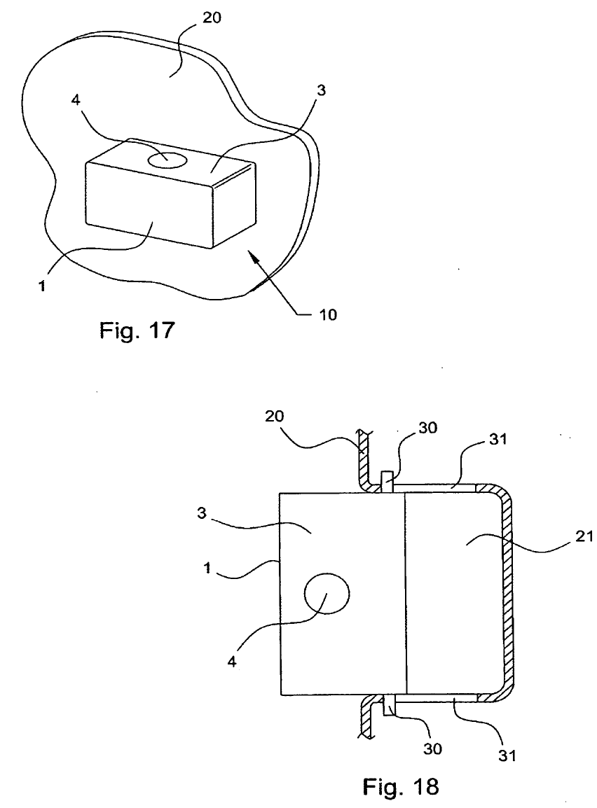

FIG. 17 shows a perspective view of another preferred embodiment of the presenting invention where mounting unit 10 is mounted in a cavity 21 of a panel 20 wherein the mounting section 3 having at least one cavity 4 is accessed by pushing on closed side 1 activating a push push switch type mechanism.

FIG. 18 is a top plan view of FIG. 17 showing the panel 20, panel cavity 21 having pin channels 31 with mounting unit 10 located therein and showing guide pins 30 located in guide pin channels 31. Also shown in FIG. 18 is mounting section 3 having at least one cavity 4 as well as closed face 1 of said mounting unit 10.

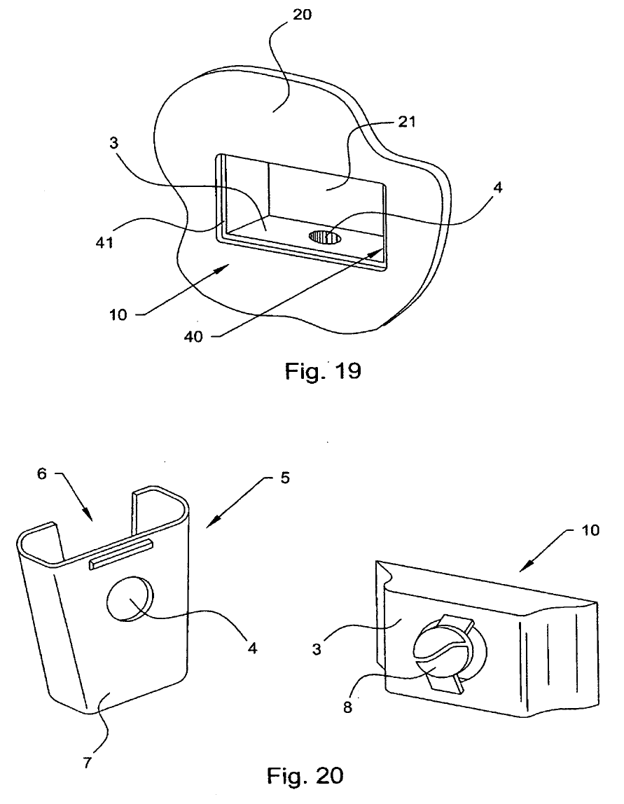

FIG. 19 shows a perspective view of yet another embodiment of the present invention having a panel 20 with a panel cavity 21 with mounting unit 10 permanently mounted therein and providing access to mounting section 3 and at least one cavity 4 by a sliding door 40 moveable in a guide track 41.

Finally, FIG. 20 shows a perspective view of an embodiment of the present invention where the at least one cavity 4 is located on the mounting side 7 of storage receptacle 5. Also shown is device storage side 6. The mounting unit 10 in this embodiment has a mounting section 3 that contains a corresponding at least one mounting stud 8. The mounting stud 8 is preferably a flexible multi-piece unit similar to that used to mount a CD in a jewel case.

It is preferable to size the vertical mounting cavities 4 such that the opening has a larger size than the bottom of the slot forming a taper. The corresponding mounting prongs 8 have a similar tapered configuration which locks the storage receptacle 5 snuggly into mounting section 3 to prevent vibration noise.

It is to be understood that reference to storage receptacle 5 throughout the specification is meant to encompass brackets for mounting items such as, for example, cell phone mounts and CD player mounts; items with the mounting prongs 8 as part of their design such as, for example, flash lights; and containers to hold items and articles such as, for example, ice chests, toolboxes, CD bins and the like.

It is also to be understood that the use of the terms “panel” and “floor” is used to encompass not only those specific areas of the interior of a vehicle but in fact any surface capable of having the present invention mounted within it and able to have a concealed closed position therein.

The universal mounting unit 10 and the storage receptacle 5 may be made from any suitable material well known in the art. Preferred materials are polypropylene, reinforced polypropylene, ABS, polycarbonate, polycarbonate/ABS, nylon, and polyacetal. It is to be further understood that the universal mounting unit 10 and the storage receptacle 5 may be made from the same or different materials suitable for the particular application.

Although the preferred embodiments of the present invention has been disclosed, various changes and modifications may be made without departing from the scope of the invention as set forth in the appended claims.

1. A device mounting apparatus suitable for attaching and securing items and receptacles having various sizes and shapes in a vehicle comprising in cooperative combination:
a mounting unit installed in one of an interior panel, interior surface, and a floor panel of a vehicle having located therein at least one mounting cavity;
storage receptacles, items, and brackets having located thereon at least one prong suitable for inserting into said at least one mounting cavity;
thereby allowing the secure attachment of at least one of a desired container, item, and bracket in a vehicle.

2. The invention as claimed in claim 1 wherein, there are a plurality of mounting cavities and a corresponding number of a plurality of corresponding prongs.

3. The invention as claimed in claim 1 wherein, said apparatus having said at least one mounting cavity and said at least one prong comprise a plastic.

4. The invention as claimed in claim 3 wherein, said plastic is selected from the group consisting of polypropylene, reinforced polypropylene, ABS, polycarbonate, polycarbonate/ABS, nylon, and polyacetal.

5. The invention as claimed in claim 1 wherein, said apparatus open and close by pivoting around a pivot pin.

6. The invention as claimed in claim 1 wherein, said apparatus open and close by means of a hinge along the one edge of said units.

7. The invention as claimed in claim 1 wherein, said at least one mounting cavity and said corresponding at least one prong are tapered.

8. The invention as claimed in claim 1 wherein, said at least one mounting cavity and said corresponding at least one prong are oriented vertically.

9. The invention as claimed in claim 1 wherein, said at least one mounting cavity and said corresponding at least one prong are oriented horizontally.

10. A device mounting apparatus suitable for attaching and securing items and receptacles having various sizes and shapes in a vehicle comprising in cooperative combination:
a mounting unit, that in its closed position it is completely hidden from view, in one of an, interior surface, panel, or floor panel of a vehicle having located therein at least one mounting cavity;
storage receptacles, items, and brackets having located thereon at least one prong suitable for inserting into said at least one mounting cavity;
thereby allowing the secure attachment of at least one of a desired container, item, and bracket in a vehicle.

11. The invention as claimed in claim 10 wherein, there are a plurality of mounting cavities and a corresponding number of a plurality of corresponding prongs.

12. The invention as claimed in claim 10 wherein, said apparatus having said at least one mounting cavity and said at least one prong comprise a plastic.

13. The invention as claimed in claim 12 wherein, said plastic is selected from the group consisting of polypropylene, reinforced polypropylene, ABS, polycarbonate, polycarbonate/ABS, nylon, and polyacetal.

14. The invention as claimed in claim 10 wherein, said apparatus open and close by pivoting around a pivot pin.

15. The invention as claimed in claim 10 wherein, said apparatus open and close by means of a hinge along one edge of said units.

16. The invention as claimed in claim 10 wherein, said at least one mounting cavity and said corresponding at least one prong are tapered.

17. The invention as claimed in claim 10 wherein, said at least one mounting cavity and said corresponding at least one prong are oriented vertically.

18. The invention as claimed in claim 10 wherein, said at least one mounting cavity and said corresponding at least one prong are oriented horizontally.

19. A device mounting apparatus suitable for attaching and securing items and receptacles having various sizes and shapes in a vehicle comprising in cooperative combination:
storage receptacles, items, and brackets having located thereon at least one mounting cavity suitable for inserting at least one mounting prong therein;
a mounting unit installed in one of an interior panel, interior surface, and a floor panel of a vehicle having located therein at least one mounting prong;
thereby allowing the secure attachment of at least one of a desired container, item, and bracket in a vehicle.

20. The invention as claimed in claim 20 wherein, said device mounting apparatus in its closed position it is completely hidden from view, in one of an, interior surface, panel, or floor panel of a vehicle.
